(19) United States
(12) Patent Application Publication
(10) Pub. No.: US 2005/0258203 A1
(43) Pub. Date: Nov. 24, 2005

(54) Retractable tether device for hand tools

(76) Inventor: William Wesley Weaver, Louisa, VA (US)

Correspondence Address: STOLL, KEENON & PARK, LLP, 300 W. VINE STREET, SUITE 2100, LEXINGTON, KY, 40507, US

(21) Appl. No.: 10/850,180

(22) Filed: May 20, 2004

(51) Int. Cl. B65H 75/40; A45F 5/00; H01R 13/72

(52) U.S. Cl. 224/162; 224/269; 224/904

(57) ABSTRACT

A retractable tether device for tools for attachment to hand tools, including power tools includes a retractable tether or cord attached to a reel for extension and retraction thereof the distal end of the cord includes an attachment device for connecting the cord to a hand tool or other implement. A cord retaining arrangement is attached to the housing on the exterior thereof to selectively retain the cord against tension from the reel and from the power tool.

### BACKGROUND OF THE INVENTION

The present invention relates broadly to retractable tether-based restraining devices and, more particularly, to a reel and retractable tether assembly for attachment to hand tools, including power tools with the reel housing including a restraining apparatus for the tether.

Workers and others use hand tools that often need to be temporarily set aside in favor of other tools or other tasks for the workers hands. It will therefore be desirable to have some form of restraint on the tool that would allow a user to release a tool yet have the tool remain within reach for further use. The present invention is described in use with a power tool, specifically a power drill. This is done for clarity, and it will be understood by those skilled in the art that the present invention has application with all forms of hand tools, including a variety of power tools.

In the recent past, a shoulder holster device similar to holsters used with firearms has been used to hold power tools. A drill or other tool can be placed in a shoulder holster and remain excisable for immediate, further use. Such holsters are primarily used with power drills.

This solution can be inadequate because a power drill in a shoulder holster can be cumbersome and although the tool remains supported, it is not restrained such that the user may drop the tool from the holster that instantly defeats the purpose of the holster.

Accordingly, there exists the need for a device to hold a hand tool or item and to retain the tool in adjustable and close proximity to the user and yet allow the user freedom of movement, without the apprehension of losing the power tool.

### SUMMARY OF THE INVENTION

It is accordingly the object of the present invention to provide a retractable power tool tether wound on a reel that will selectively retain a hand tool.

To that end, a retractable tether device for tools for a power tool includes a housing containing a spring-biased reel having a tether cord or strand wrapped thereabout for selective release and take-up. The housing fully encloses the reel and cord with the cord projecting from a single opening in the housing. A clasp, hook or other like member is attached to the free end of the cord for engagement with a power tool or other device.

While the present application discusses the tethered item as a power tool, it should be understood that the present invention is capable of many uses and should not in any way be limited to use with a power tool.

The cord is biased for automatic retraction and winding on the reel. In order to use the power tool attached to the cord, tension must be reduced in the cord so that the reel is not constantly trying to wind the cord and, therefore, the power tool back onto the reel. To that end, the present invention provides a cord retainer arrangement that is formed from two converging rail segments that are mounted to the housing. The cord may be wedged intermediate the rail segments for tension reduction on the cord.

To those ends, a retractable tether device for tools includes a housing and a reel disposed within the housing, the reel being biased for rotation in a rewinding direction. A cord attached is to the reel at a first end of the cord with a distal end of the cord free of the reel. A tool retainer device is attached to the distal end of the cord and a cord retainer arrangement is attached to an outer surface of the housing. The cord retainer arrangement defines an opening for passage of the cord therethrough, the opening being formed with an operational region wherein the cord is allowed free motion in and out of the housing, and a retaining region wherein the cord is prevented from movement in and out of the housing, wherein the cord is selectively movable between the operational region for cord movement and the retaining region for cord retention.

The retractable tether device for tools preferable includes a housing retainer member, preferable formed as a belt clip attached to the housing for attachment of the tether device to a support object.

Preferably, the housing is formed as a generally hollow cylinder defining a receiving well having the reel disposed therein. Also preferably included is a reel cover mounted to the housing in registry with the receiving well, and an end cap and a spindle with the end cap mounted thereto with the reel rotatably mounted to the spindle. It is preferred that a hub member is mounted to the housing at the spindle and a threaded member is provided for retaining the hub member in abutment with the reel cover.

According to one preferred embodiment of the present invention, the cord retaining arrangement includes at least two generally parallelly extending rail segments mounted to the housing and defining a spacing therebetween. Preferably, the rail segments extend at a first spacing defining the retaining region and a second spacing defining the operational region. The present invention may also include a bracing member mounted to the rail segments adjacent the operational region.

According to another preferred embodiment of the present invention, the cord retainer is formed as curved member having the opening formed therein with the retainment region having edges that converge to a position wherein the facing edges are closer together than the thickness of the cord for cord retention therebetween. It is preferred that the operational region is defined by an opening formed in the plate larger than the retaining region for free movement of the cord therein. Additionally, the retaining region may be substantially V-shaped and opens to the operational region. It is preferred that the retaining region is substantially vertically oriented and the operational region is substantially horizontally oriented.

It is preferable that the tool retainer device include a hook for attachment to one of the cord and the tool for retainment of the tool by the cord. Further, the tool retainer device preferably includes a closure member attached to the hook and biased to a closed position.

The preferred embodiments can be described in greater detail as a retractable tether device for tools including a generally cylindrical housing including a spindle and a reel rotatably mounted to the spindle within the housing, the reel being biased for rotation in a rewinding direction. A cord is attached to the reel at a first end of the cord with a distal end of the cord free of the reel. A tool retainer device including a hooked member is attached to the distal end of the cord.

The present invention further includes a cord retainer arrangement attached to an outer surface of the housing and defining an opening for passage of the cord therethrough, the opening being formed with an operational region wherein the cord is allowed free motion in and out of the housing, and a retaining region wherein the cord is prevented from movement in and out of the housing. The cord is selectively movable between the operational region for cord movement and the retaining region for cord retention, with the cord retainer arrangement including at least two generally parallelly extending rail segments mounted to the housing and defining a spacing therebetween. The rail segments extend at a first spacing defining the retaining region and a second spacing defining the operational region.

The present invention preferably includes a housing retainer member attached to the housing for attachment of the tether device to a support object. Preferably, the housing retainer member includes a belt clip for attaching the tether device to the belt of a user.

According to another preferred embodiment of the present invention, a retractable tether device for tools includes a generally cylindrical housing including a spindle and a reel rotatably mounted to the spindle within the housing, the reel being biased for rotation in a rewinding direction. A cord is attached to the reel at a first end of the cord with a distal end of the cord free of the reel. A tool retainer device is provided and includes a hooked member attached to the distal end of the cord.

A cord retainer arrangement is attached to an outer surface of the housing and defining an opening for passage of the cord therethrough, the opening being formed with an operational region wherein the cord is allowed free motion in and out of the housing, and a retaining region wherein the cord is prevented from movement in and out of the housing. The cord is selectively movable between the operational region for cord movement and the retaining region for cord retention. The cord retainer is formed as curved member having the opening formed therein with the retainment region having edges that converge to a position wherein the facing edges are closer together than the thickness of the cord for cord retention therebetween. The operational region is defined by an opening formed in the plate larger than the retaining region for free movement of the cord therein and the retaining region is substantially V-shaped and opens to the operational region.

It is preferred that the retaining region is substantially vertically oriented and the operational region is substantially horizontally oriented.

The converging nature of the rail segments directs a loose cord into the retention region if the tool is dropped or otherwise released by the user.

The present invention preferably further includes a housing retainer member attached to the housing for attachment of the tether device to a support object. Preferably, the housing retainer member includes a belt clip for attaching the tether device to the belt of a user.

### BRIEF DESCRIPTION OF THE DRAWINGS

FIG. 1 is an elevational view of a retractable tether device for tools for power tools according to one preferred embodiment of the present invention;

FIG. 2 is a top view of the retractable tether device for tools illustrated in FIG. 1 with the free end of the tether secured around a power tool handle;

FIG. 3 is a top view of the retractable tether device for tools illustrated in FIG. 2 with the cord being held fast by the cord retainer;

FIG. 4 is a top elevational view of the retractable tether device for tools illustrated in FIG. 2 with the cord free of the cord retainer;

FIG. 5 is a top elevational view of the retractable tether device for tools illustrated in FIG. 2 with the cord being held by the cord retainer;

FIG. 6 is an elevational view of a retractable tether device for tools for power tools according to another preferred embodiment of the present invention;

FIG. 7 is a top view of the retractable tether device for tools illustrated in FIG. 6 with the free end of the tether secured around a power tool handle;

FIG. 8 is a top view of the retractable tether device for tools illustrated in FIG. 6 with the cord being held by the cord retainer;

FIG. 9 is a top elevational view of the retractable tether device for tools illustrated in FIG. 6 with the cord free of the cord retainer;

FIG. 10 is a top elevational view of the retractable tether device for tools illustrated in FIG. 10 with the cord being held by the cord retainer;

FIG. 11 is an elevational view of a retractable tether device for tools for power tools according to another preferred embodiment of the present invention;

FIG. 12 is a front view of the retractable tether device for tools illustrated in FIG. 11;

FIG. 13 is a right side view of the retractable tether device for tools illustrated in FIG. 11;

FIG. 14 is a top plan view of the retractable tether device for tools illustrated in FIG. 11;

FIG. 15 is an exploded view of the retractable tether device for tools illustrated in FIG. 11;

FIG. 16 is an elevational view of a retractable tether device for tools for power tools according to one preferred embodiment of the present invention;

FIG. 17 is a top view of the retractable tether device for tools illustrated in FIG. 16 with the free end of the tether secured around a power tool handle;

FIG. 18 is a top plan view of the retractable tether device for tools illustrated in FIG. 16 with the cord being held by the cord retainer;

FIG. 19 is a top elevational view of the retractable tether device for tools illustrated in FIG. 16 with the cord free of the cord retainer; and

FIG. 20 is a top elevational view of the retractable tether device for tools illustrated in FIG. 16 with the cord being held by the cord retainer.

### DESCRIPTION OF THE PREFERRED EMBODIMENT

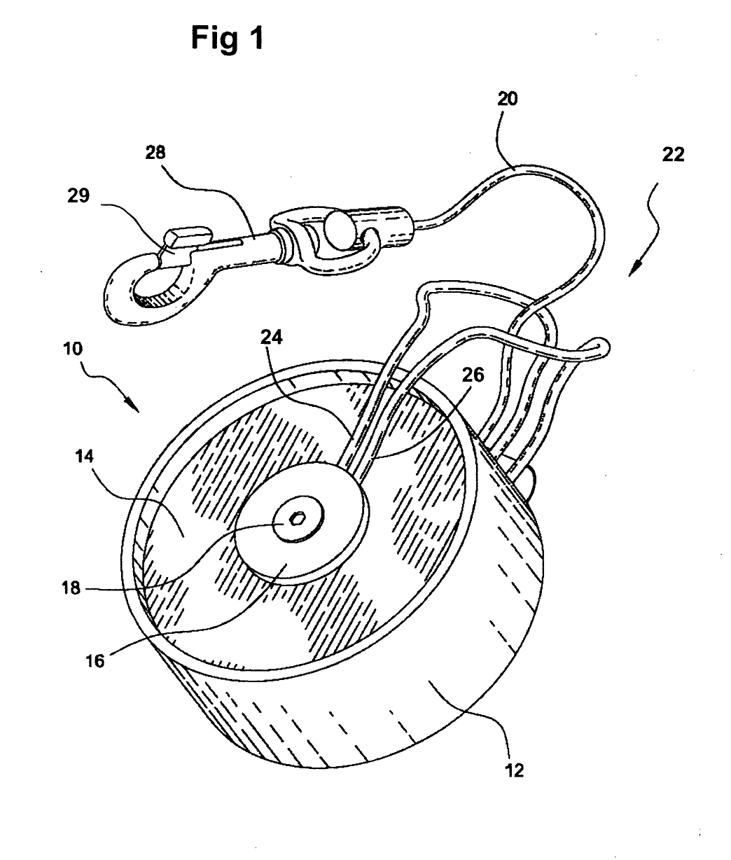

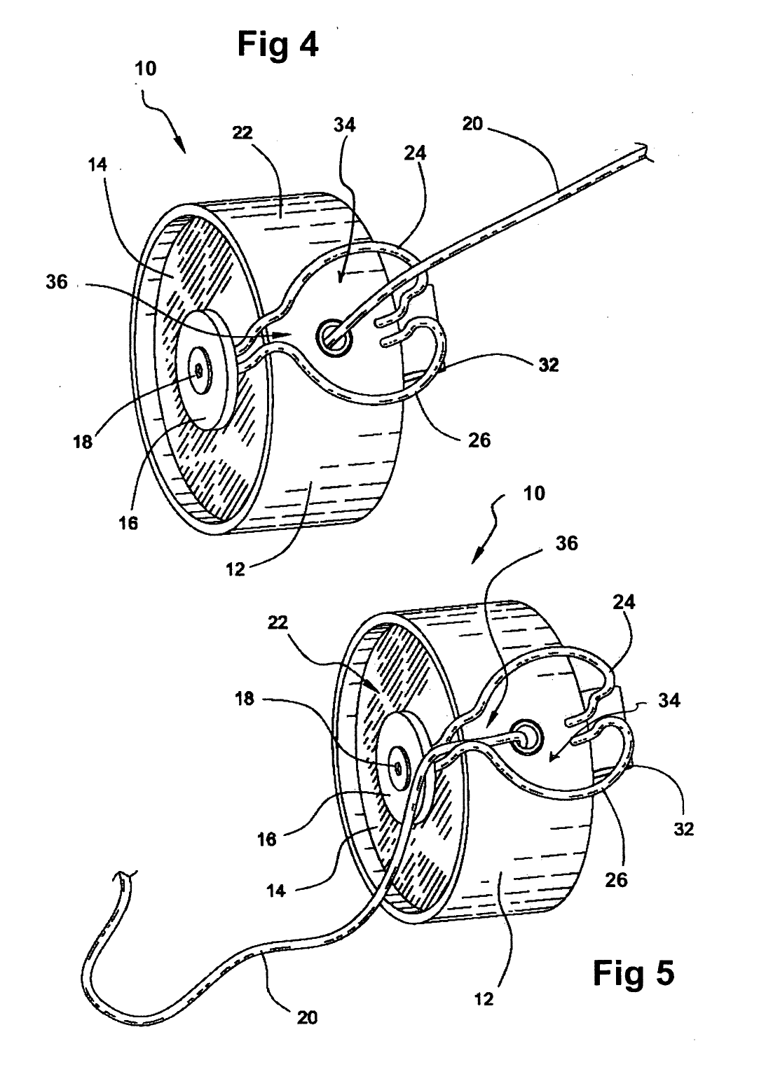

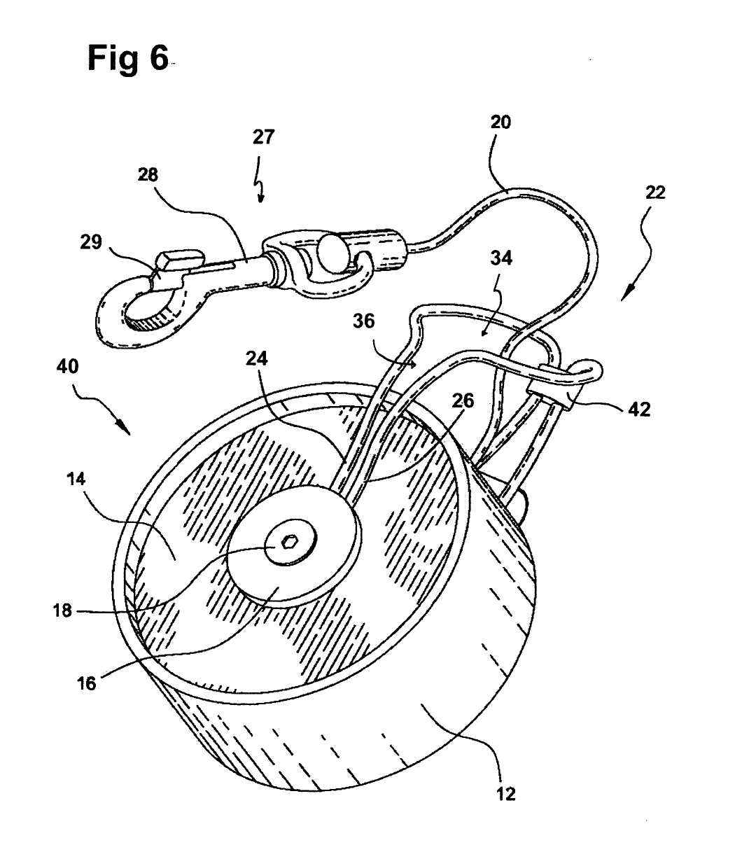

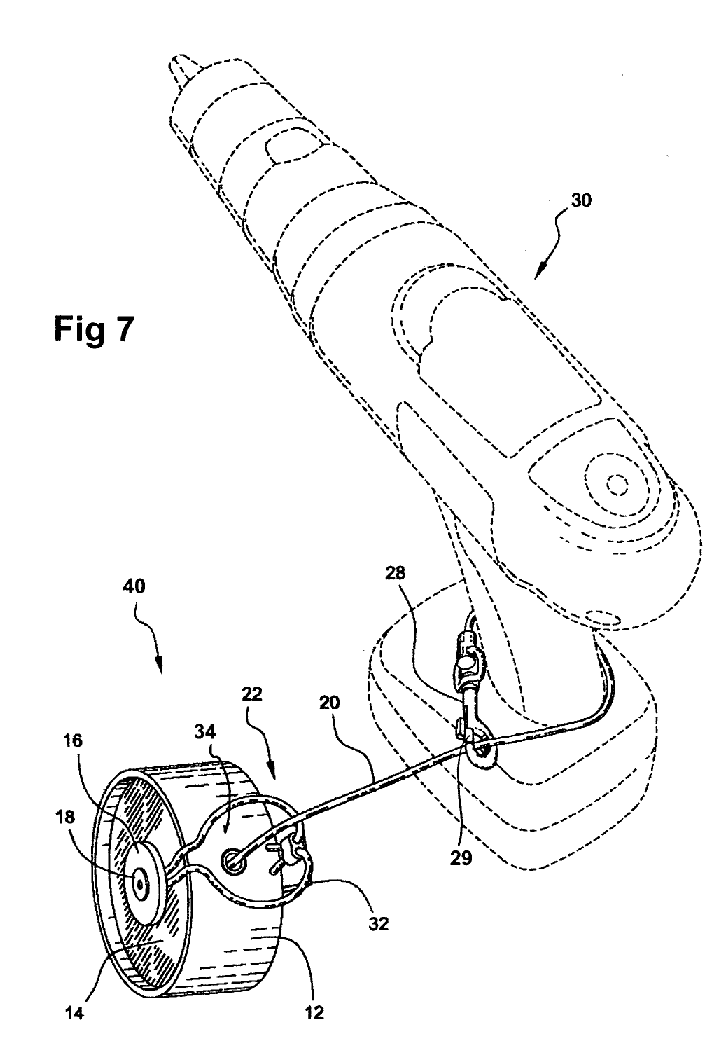

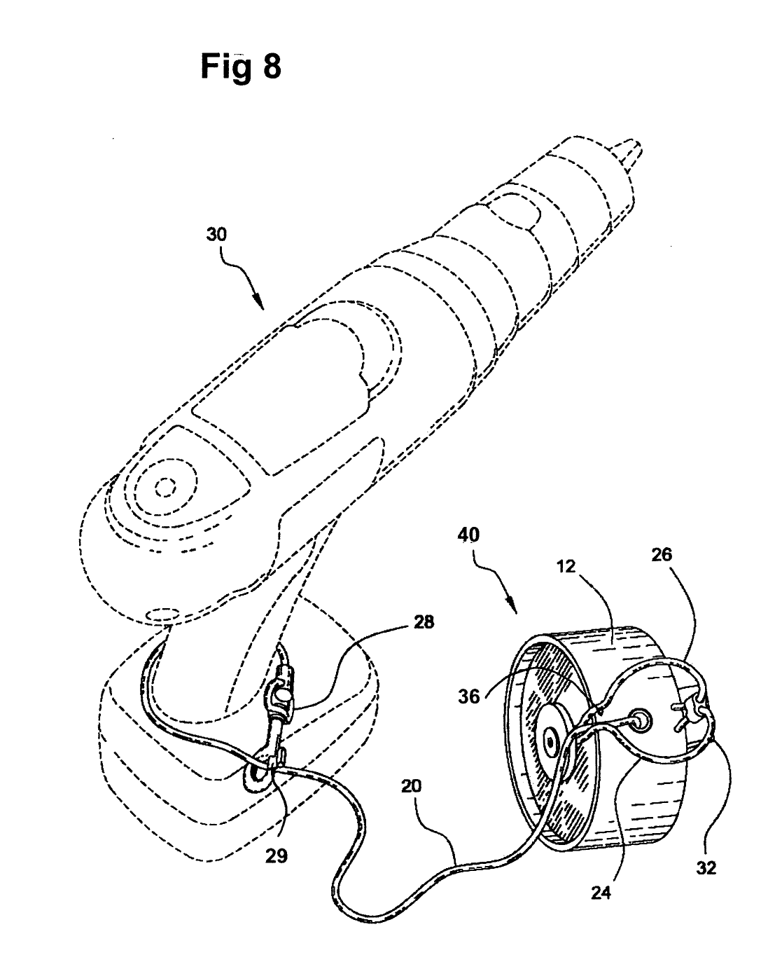

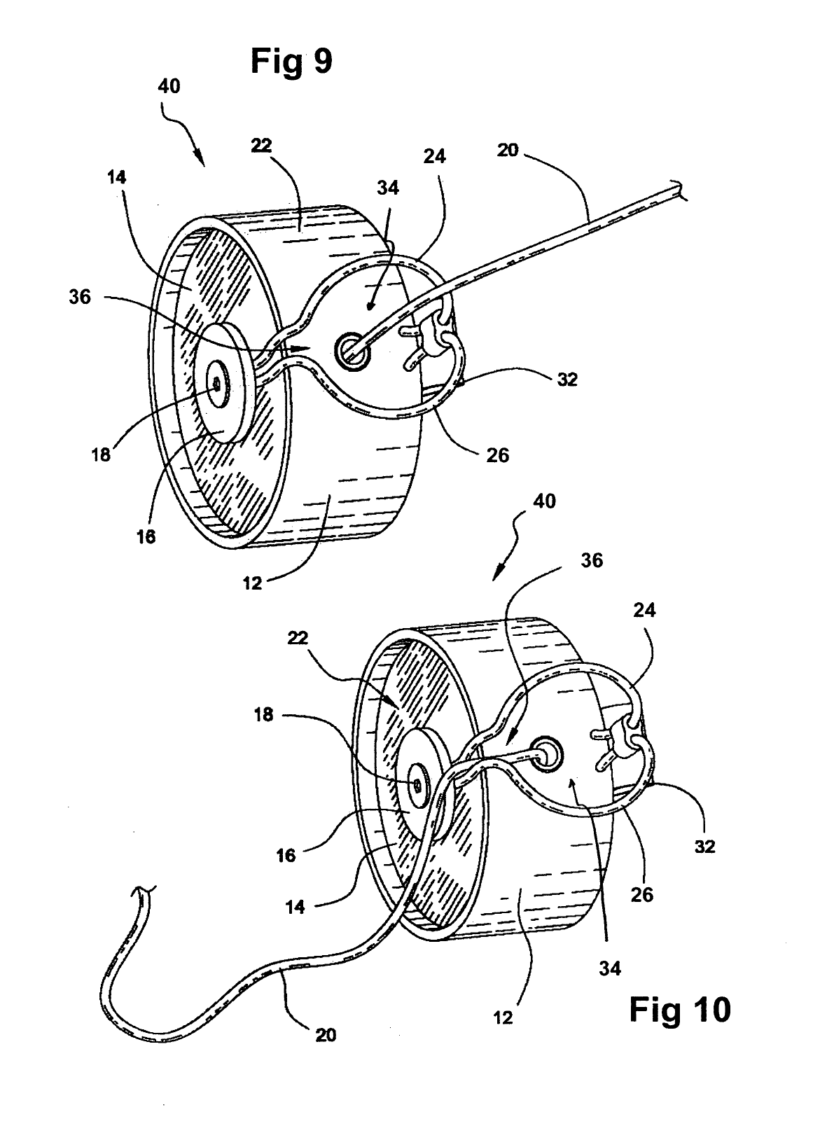

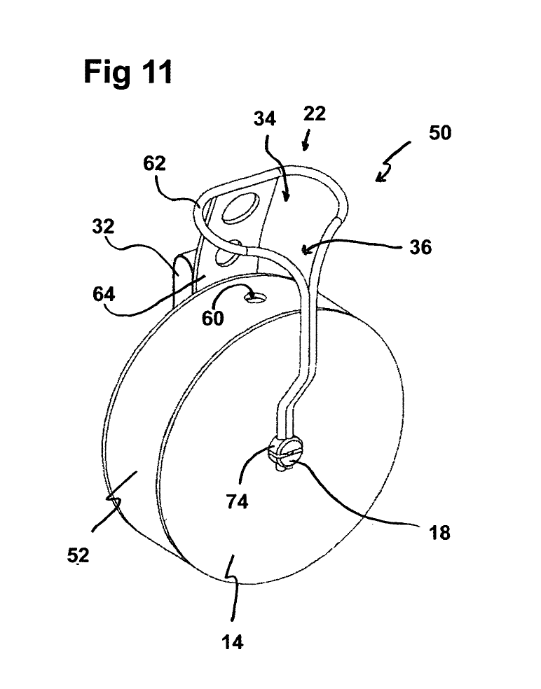

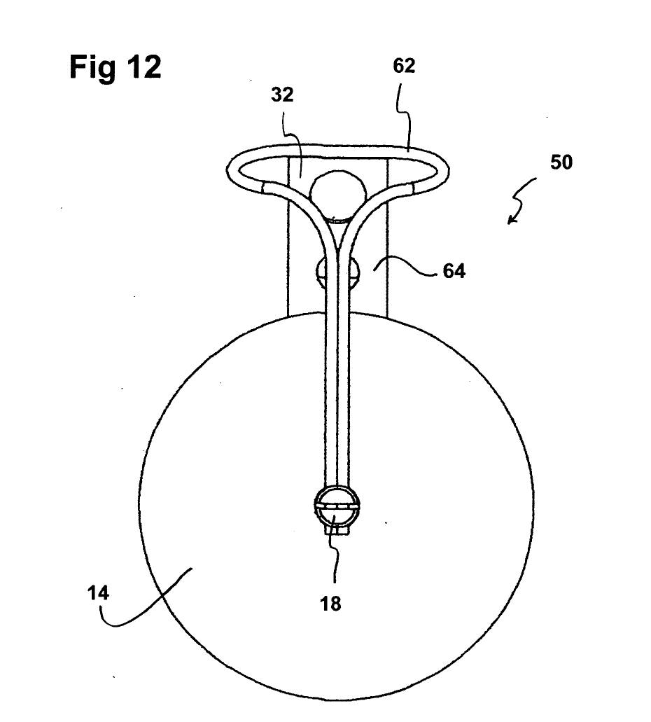

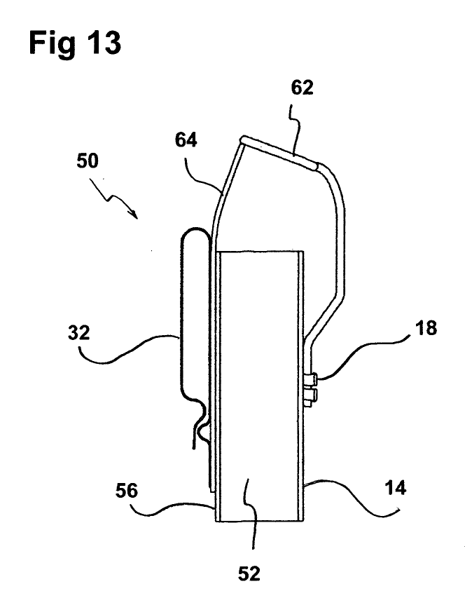

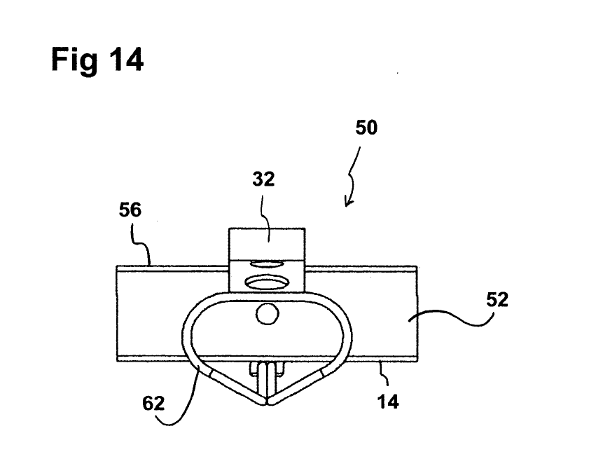

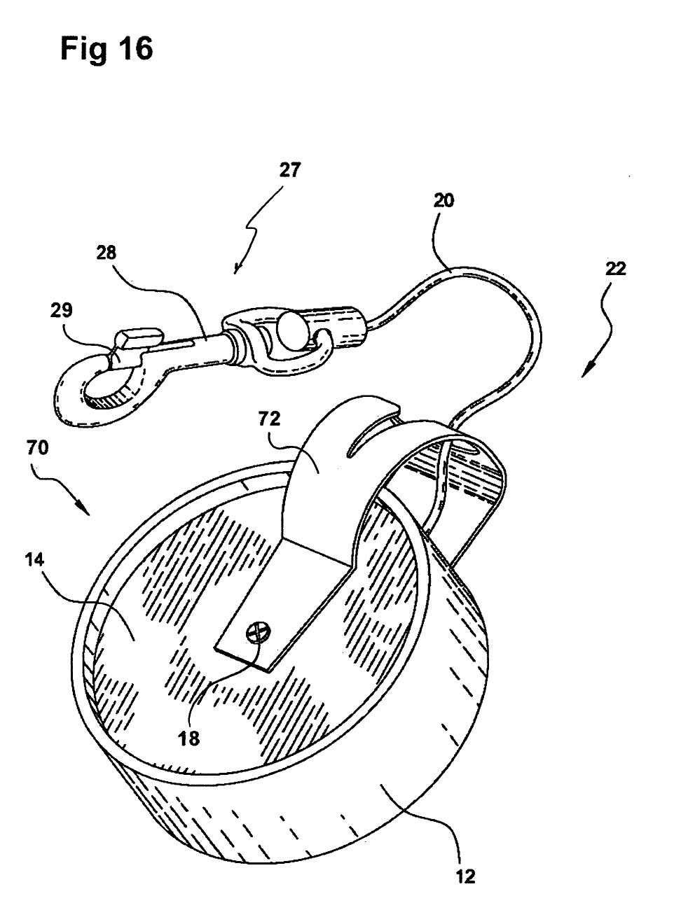

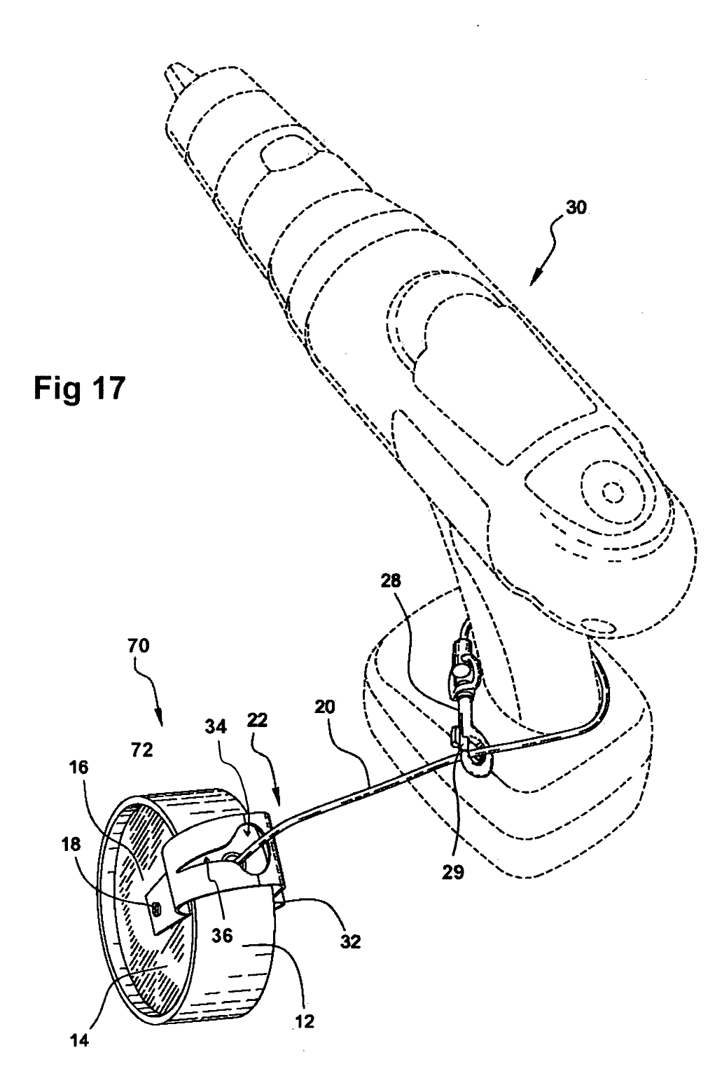

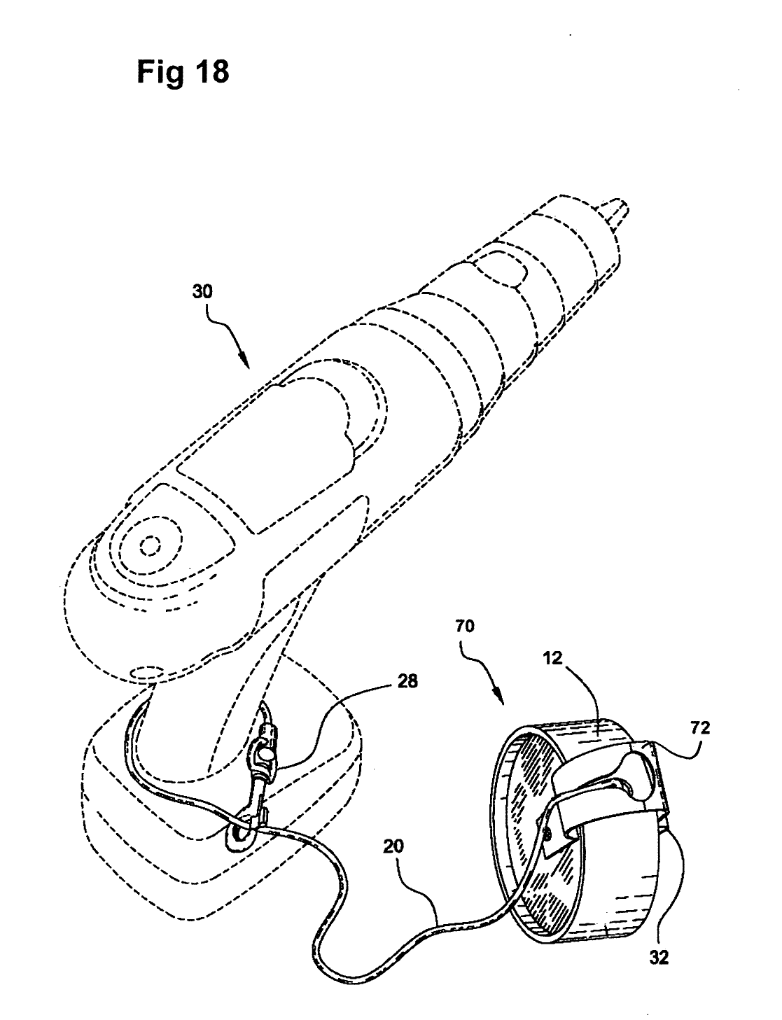

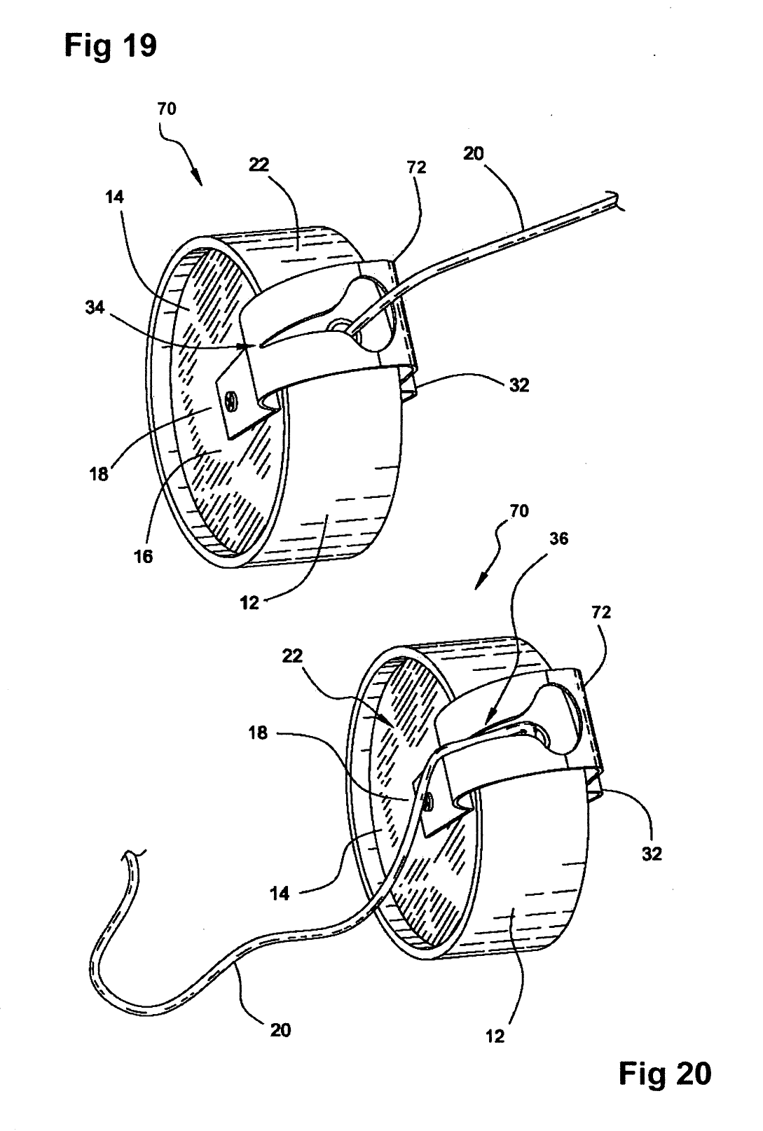

The present invention is illustrated in four different preferred embodiments. The first preferred embodiment is illustrated in FIGS. 1-5. The second preferred embodiment is illustrated in FIGS. 6-10. The third preferred embodiment is illustrated in FIGS. 11-15, and the fourth preferred embodiment is illustrated in FIGS. 16-20. Each preferred embodiment includes a common housing structure and each is differentiated by a unique cord control structure, as will be explained in greater detail hereinafter. The Figures use common reference numerals for structural elements common to all embodiments, and each embodiment along with the unique structural elements associated therewith have different reference numerals, even though such structural elements may perform like functions. The first preferred embodiment will be explained below, followed by descriptions of how the remaining embodiments differ structurally.

Even though there are structural differences between the preferred embodiments, operation of the device remains essentially constant across the range of preferred embodiments.

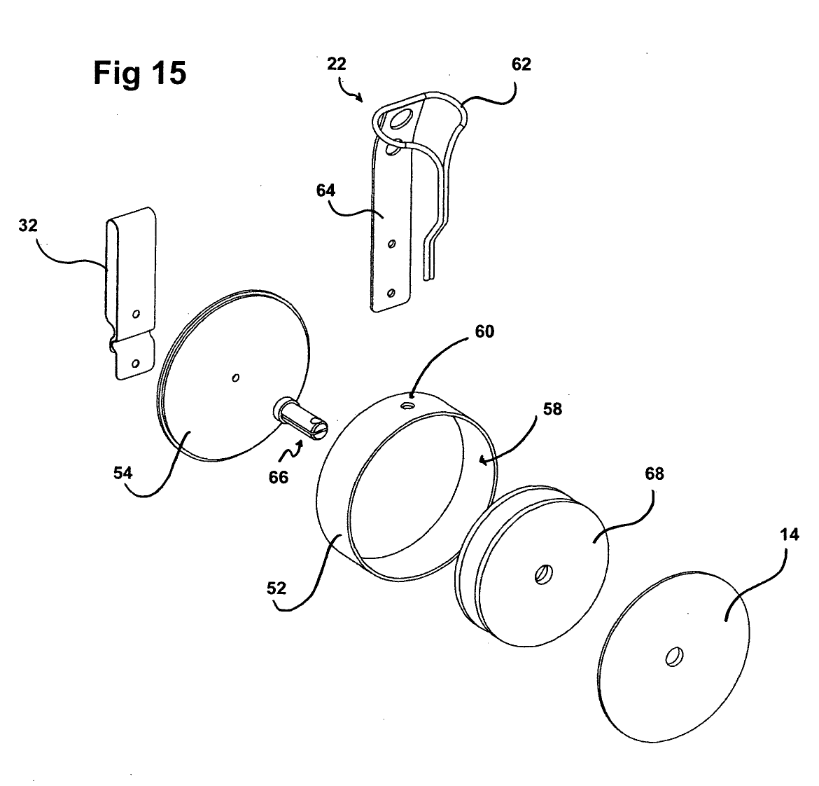

Turning now to FIG. 1, a retractable tether device for attachment to tools is illustrated generally at 10 and includes a generally cylindrical reel housing 12 having a washer-like end cap 14 mounted thereto. The housing 12 may be cast as a hollow, capped cylinder, or formed as a tube-like cylinder, illustrated at 52 in FIG. 15. With continued reference to FIG. 15, a spring-biased reel assembly 68 is disposed within the housing 52. Although the spring mechanism is not illustrated in the present figures, a spring-biased retractable cord and reel assembly is a common structure and it will not be beyond the skill of those skilled in this art to construct such a mechanism. The cylindrical housing 52 defines a receiving well 58 for the reel assembly 68, that is in turn mounted to a spindle 66. The spindle 66 is mounted to the center of one end cap 54 and another, optional end cap 14 covers the reel assembly 58. The embodiment in FIG. 15 will be addressed in greater detail hereinafter.

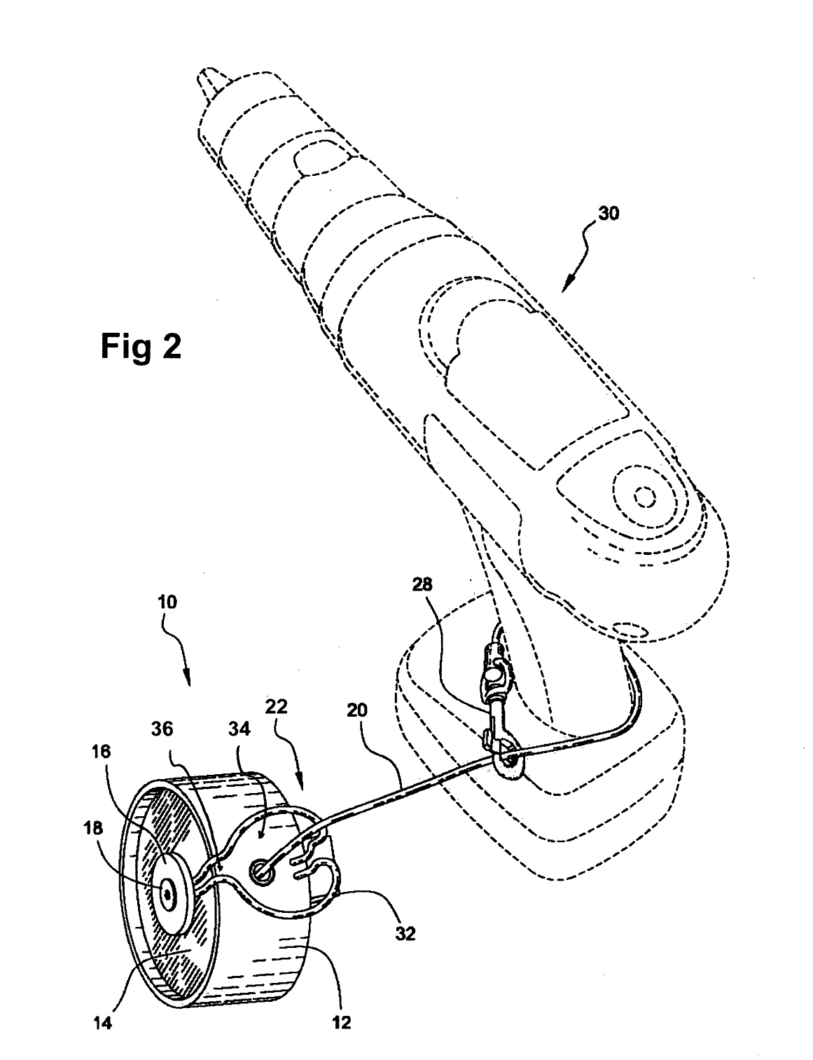

Returning now to FIGS. 1-5, the end cap 14 may be held in place on the housing 12 by a hub 16 and a screw 18 disposed along the end cap 14 in substantially the center thereof. A tether formed as a strand or a cord 20 projects outwardly from an opening 60 formed in one side of the housing 12 and is terminated with a tool retaining device 27, including a hook 28 and a spring-biased closure member 29. The hook 28 may directly engage a power tool 30 or may be connected to the cord 20, as seen in FIGS. 2, 3 and 4.

As best seen in FIGS. 1, 4 and 5, a tether retaining apparatus, or cord retaining arrangement is illustrated generally at 22 and includes a first curved rail segment 24 and a second curved rail segment 26. The rail segments 24, 26 are secured to the hub 16 and extend parallelly for a predetermined distance to a spacer disposed near the edge of housing 12 and from that point, the rail segments, 24, 26 curve through approximately 180 degrees and reenter the housing 12, where they are fixed in place. The rail segments 24, 26 diverge from one another as each curves around toward the housing 12. This defines a spacing that converges or closes as the gripping members extend away from the belt clip 32, and toward the hub 16. The spacing is therefore variable along the length of the rail segments 24, 26. Accordingly, the rail segments 24,26 define two distinct regions, an operational region and a cord retainment region. Within the cord retainment region, the converging spacing is configured to accept and selectively, frictionally retain the cord according to user manipulation. This allows a user to define a certain length of cord that remains slack, free of the retainer for comfortable and effective tool use.

In operation, and with reference to FIGS. 2-5, the retractable tether device for tools is shown attached to a power drill 30 with the cord 20 extending away from the retractable tether device 10 and looped around the handle of the drill 30. The cord 20 is secured around the handle of the drill 30 using the hook 28 and closure member 29, in a manner similar to a belt hook used on a key holder. To extend the cord 20 from the reel, the user must move the drill 30 and the accompanying cord 20 outwardly into the operational region and toward the belt clip 32 which, in turn, would mean drawing the cord 20 toward the body of the user and outwardly from the reel 68 for use. Once the cord is at a comfortable length, the cord can be manipulated into the retainment region, with the drill freely operable attached to a cord having a user-selected effective length.

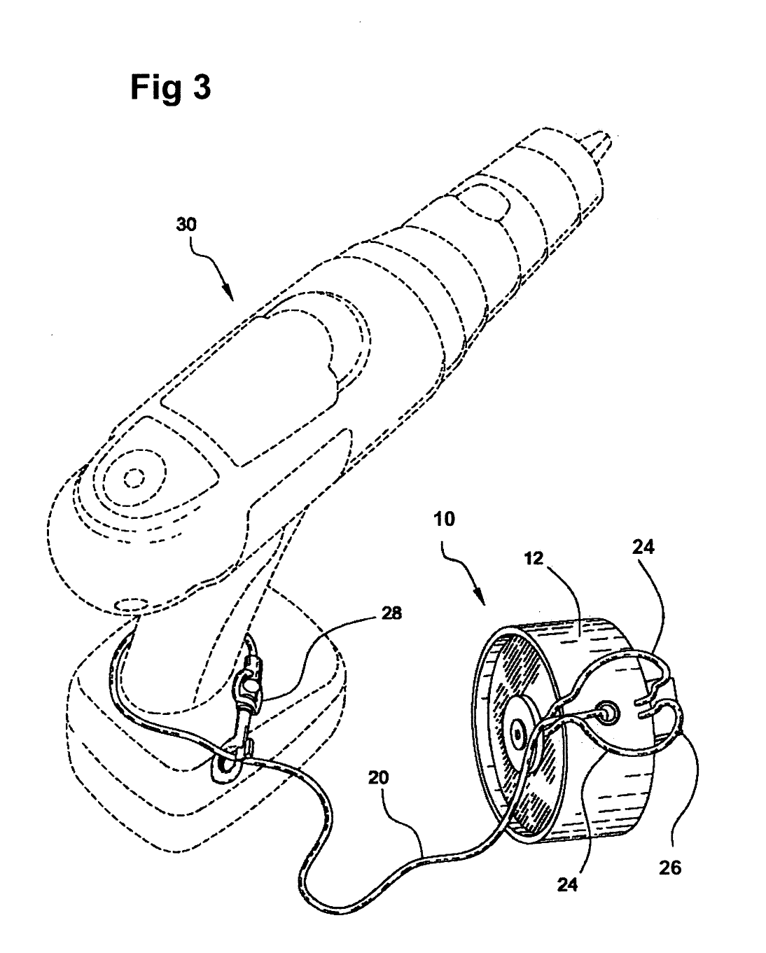

Once the user of the drill ceases drilling, and wants to use his or her hands for another task, the cord may be allowed to retract and then moved to a retained position as seen in FIGS. 3 and 5 with the cord 20 being in the narrowest portion of the retainment region defined by the rail segments 24, 26 which hold the cord fast, against both the pull of the reel spring and the weight of the drill. In this matter, the drill may be suspended, a predetermined distance away from the retractable tether device 10 and within reach of the user.

The second preferred embodiment is illustrated in FIGS. 6-10. The cord retainer arrangement 22 of the second preferred embodiment includes a rail bracing member 42 that is formed from a block of metal. Both rail segments 24, 26 pass through the rail bracing member 42. The rail bracing member 42 adds structural integrity to the rail system, as illustrated generally in FIGS. 6- 10.

A third preferred embodiment is illustrated in FIGS. 11-15. FIG. 15 has been discussed previously with respect to the housing structure. Turning to FIG. 11, the cord retainer arrangement 22 includes a single rail 62 formed into a loop and mounted to a plate 64 that extends intermediate the belt clip 32 and the inner end cap 54. The looped configuration of the rail segment 62 defines the operational region 34 and the retainment region 36 of the spacing created by looped rail 62. In FIG. 11, two end portions of the rail segment 62 extend in a parallel relationship with one another to the center of the outer cap 14 where they are held by a generally cylindrical rail attachment member 74. The rail attachment member 74 is formed as a generally hollow cylinder having an opening in the side thereof. The side opening allows two portions of the rail segment 62 to extend thereinto. A screw 18 extends down the bore of the cylinder for threaded engagement with the spindle 66 as seen in FIG. 15. Although the end portions of the rail segment 62 extend in a side-by-side relationship, it may be that the rail portions overlap one another depending on the desires of the manufacturer. If the rail segment 62 end portions are arranged one on top of another, the resulting change in shape of the retainment region 36 would provide a lateral bias for the cord 20 in the general direction of the rail portion that is in abutment with the outer end cap 14.

A fourth preferred embodiment is illustrated in FIG. 16-20. There, the cord control arrangement 22 includes a generally flat plate extending from one end cap across the outer wall of the cylindrical housing 12 and to the center of the outer end cap 14. For stability, a portion of the plate 72 is flat against the outer cap 14 while the remainder of the plate 72 curves through 180 degrees. The portion of the plate 72 defining this curvature has an opening formed therein defined by relatively thin edge walls. These edge walls define the operational region and the retainment region of the cord control spacing.

Operation of the foregoing embodiments is essentially the same throughout all four versions and will not be repeated.

By the above, the present retractable tether device for tools for hand tools 10 allows use of the open V-shaped gap of the cord retainer arrangement 22 to allow secure access for a tool 30 in addition to the ability to hold the cord 20, and therefore the tool 30 in the event the tool 30 is dropped.

It will therefore be readily understood by those persons skilled in the art that the present invention is susceptible of a broad utility and application. While the present invention is described in all currently foreseeable embodiments, there may be other, unforeseeable embodiments and adaptations of the present invention, as well as variations, modifications and equivalent arrangements, that do not depart from the substance or scope of the present invention. The foregoing disclosure is not intended or to be construed to limit the present invention or otherwise to exclude such other embodiments, adaptations, variations, modifications and equivalent arrangements, the present invention being limited only by the claims appended hereto and the equivalents thereof.

1. A retractable tether device for tools comprising:
a housing;
a reel disposed within said housing, said reel being biased for rotation in a rewinding direction;
a cord attached to said reel at a first end of said cord with a distal end of said cord free of said reel;
a tool retainer device attached to said distal end of said cord; and
a cord retainer arrangement attached to an outer surface of said housing and defining an opening for passage of said cord therethrough, said opening being formed with an operational region wherein said cord is allowed free motion in and out of said housing, and a retaining region wherein said cord is prevented from movement in and out of said housing, said cord being selectively movable between said operational region for cord movement and said retaining region for cord retention.

2. A retractable tether device for tools according to claim 1 and further comprising a housing retainer member attached to said housing for attachment of said tether device to a support object.

3. A retractable tether device for tools according to claim 2 wherein said housing retainer member includes a belt clip for attaching said tether device to the belt of a user.

4. A retractable tether device for tools according to claim 1 wherein said housing is formed as a generally hollow cylinder defining a receiving well having said reel disposed therein.

5. A retractable tether device for tools according to claim 4 and further comprising a reel cover mounted to said housing in registry with said receiving well.

6. A retractable tether device for tools according to claim 5 and further comprising an end cap and a spindle with said end cap mounted thereto with said reel rotatably mounted to said spindle.

7. A retractable tether device for tools according to claim 6 and further comprising a hub member mounted to said housing at said spindle and a threaded member for retaining said hub member in abutment with said reel cover.

8. A retractable tether device for tools according to claim 1 wherein said cord retaining arrangement includes at least two generally parallelly extending rail segments mounted to said housing and defining a spacing therebetween.

9. A retractable tether device for tools according to claim 8 wherein said rail segments extend at a first spacing defining said retaining region and a second spacing defining said operational region.

10. A retractable tether device for tools according to claim 9 and further comprising a bracing member mounted to said rail segments adjacent said operational region.

11. A retractable tether device for tools according to claim 1 wherein said cord retainer is formed as curved member having said opening formed therein with said retainment region having edges that converge to a position wherein said facing edges are closer together than the thickness of said cord for cord retention therebetween.

12. A retractable tether device for tools according to claim 11 wherein said operational region is defined by an opening formed in said plate larger than said retaining region for free movement of said cord therein.

13. A retractable tether device for tools according to claim 12 wherein said retaining region is substantially V-shaped and opens to said operational region.

14. A retractable tether device for tools according to claim 13 wherein said retaining region is substantially vertically oriented and said operational region is substantially horizontally oriented.

15. A retractable tether device for tools according to claim 1 where said tool retainer device includes a hook for attachment to one of said cord and said tool for retainment of said tool by said cord.

16. A retractable tether device for tools according to claim 15 wherein said tool retainer device includes a closure member attached to said hook and biased to a closed position.

17. A retractable tether device for tools comprising:
a generally cylindrical housing including a spindle;
a reel rotatably mounted to said spindle within said housing, said reel being biased for rotation in a rewinding direction;
a cord attached to said reel at a first end of said cord with a distal end of said cord free of said reel;
a tool retainer device including a hooked member attached to said distal end of said cord; and
a cord retainer arrangement attached to an outer surface of said housing and defining an opening for passage of said cord therethrough, said opening being formed with an operational region wherein said cord is allowed free motion in and out of said housing, and a retaining region wherein said cord is prevented from movement in and out of said housing, said cord being selectively movable between said operational region for cord movement and said retaining region for cord retention, with said cord retainer arrangement including at least two generally parallelly extending rail segments mounted to said housing and defining a spacing therebetween, wherein said rail segments extend at a first spacing defining said retaining region and a second spacing defining said operational region.

18. A retractable tether device for tools according to claim 17 and further comprising a housing retainer member attached to said housing for attachment of said tether device to a support object.

19. A retractable tether device for tools according to claim 18 wherein said housing retainer member includes a belt clip for attaching said tether device to the belt of a user.

20. A retractable tether device for tools comprising:
a generally cylindrical housing including a spindle;
a reel rotatably mounted to said spindle within said housing, said reel being biased for rotation in a rewinding direction;
a cord attached to said reel at a first end of said cord with a distal end of said cord free of said reel;
a tool retainer device including a hooked member attached to said distal end of said cord; and
a cord retainer arrangement attached to an outer surface of said housing and defining an opening for passage of said cord therethrough, said opening being formed with an operational region wherein said cord is allowed free motion in and out of said housing, and a retaining region wherein said cord is prevented from movement in and out of said housing, said cord being selectively movable between said operational region for and said retaining region, wherein said cord retainer is formed as curved member having said opening formed therein with said retainment region having edges that converge to a position wherein said facing edges are closer together than the thickness of said cord for cord retention therebetween, wherein said operational region is defined by an opening formed in said plate larger than said retaining region for free movement of said cord therein and wherein said retaining region is substantially V-shaped and opens to said operational region.

21. A retractable tether device for tools according to claim 13 wherein said retaining region is substantially vertically oriented and said operational region is substantially horizontally oriented.

22. A retractable tether device for tools according to claim 20 and further comprising a housing retainer member attached to said housing for attachment of said tether device to a support object.

23. A retractable tether device for tools according to claim 22 wherein said housing retainer member includes a belt clip for attaching said tether device to the belt of a user.
